(19) United States
(12) Patent Application Publication
(10) Pub. No.: US 2024/0012402 A1
(43) Pub. Date: Jan. 11, 2024

(54) METHOD AND SYSTEMS FOR SIMULATING DRIVE DEVICES

(71) Applicant: Siemens Aktiengesellschaft, München (DE)

(72) Inventors: Christian NEUGEBAUER, Nürnberg (DE); Martin SCHÄFER, Niederdorf (DE)

(73) Assignee: Siemens Aktiengesellschaft, München (DE)

(21) Appl. No.: 18/267,391

(22) PCT Filed: Dec. 1, 2021
(86) PCT No.: PCT/EP2021/083708

§ 371 Date: Jun. 14, 2023

(30) Foreign Application Priority Data
Dec. 15, 2020 (EP) 20214172.7

(51) Int. Cl. G05B 19/418

(52) U.S. Cl. CPC G05B 19/41885

(57) ABSTRACT

A computer-implemented method provides a time-dependent simulation model of a drive device. The drive device comprises an electric machine and a supply unit associated with the electric machine. A functional scope of the time-dependent simulation model is defined. A virtual image of the drive device is provided. The virtual image is modularly constructed, each module of the virtual image being configurable. In order to establish the time-dependent simulation model of the drive device with the defined functional scope, in accordance with the functional scope at least one module of the virtual image is selected and the at least one module is configured with respect to its level of detail.

The invention relates to a computer-implemented method for providing a time-dependent simulation model of a drive device, the drive device comprising an electric machine, for example an electric rotary machine, in particular a motor and a supply unit associated with the electric machine, said supply unit comprising a control facility, for example a converter, in particular a servo converter, low-voltage converter or frequency converter, wherein
a functional scope of the time-dependent simulation model is defined,
a virtual mapping of the drive device, preferably of the entire drive device, is provided.

The electric machine, in particular the motor, can in this case be designed to be multi-axial, wherein each axis can be controlled by the control facility. The control facility can be designed as a subassembly.

The invention additionally relates to a computer-aided method for simulating the behavior of a drive device in an environment.

The invention additionally relates to a use of a time-dependent simulation model provided in accordance with the aforementioned method. The use relates in particular to use for the purpose of simulating the behavior of the drive device.

The invention further relates to a computer program containing commands, which on execution of the computer program by a computer cause said computer to execute the aforementioned method for providing a time-dependent simulation model.

The invention further relates to a system, in particular an engineering platform, which comprises means for the execution of at least one of the above-mentioned computer-implemented methods.

As well, the invention relates to a computer-readable storage medium with the aforementioned computer program and a data stream which is adapted such that it transmits the aforementioned computer program.

Computer-implemented methods and time-dependent simulation models of the drive devices of the aforementioned type are known from the prior art. The provision of a time-dependent simulation model almost always poses a dilemma: on the one hand, the customer wishes the simulative mapping (the simulation model) of drive devices (often a combination of a frequency converter and an electric motor) to be easy to operate and/or parameterize, while on the other hand a particular functional scope is expected of the simulation model—for example it simulates the behavior of the drive device only as precisely as is necessary. In this way many simulation models can arise, wherein different models have a different functional scope in the event of a low functional overlap. A technical solution may therefore frequently appear to be only very customer-specific, since in essence it is only desired to vary that part of a simulation model which is the focus of the examination. Hitherto there has therefore been no general technical solution, but only mapping of the devices in specific simulation tools either in a concrete functional form or with a minimal functional scope, in order to cover a wide circle of users. In other words a simulation model in accordance with the prior art is either a more or less exact mapping of the real firmware or a specific reproduction of just a few partial aspects.

The object of the present invention can thus be regarded as providing methods and systems that enable a flexible provision of the simulation models of drive devices that is dependent on a defined functional scope.

The object of the invention is inventively achieved with a computer-implemented method of the aforementioned type, in that the virtual mapping is modularly constructed and preferably comprises at least two different modules, in particular a plurality of different modules, wherein each module of the virtual mapping is configurable, wherein, in order to establish the time-dependent simulation model of the drive device with the defined functional scope, in accordance with the functional scope at least one module, preferably multiple modules, of the virtual mapping are selected and—likewise in accordance with the functional scope—the one or more modules are configured with respect to their level of detail, for example via a configuration interface of the time-dependent simulation model. As a result, the desired flexibility in the provision of the time-dependent simulation model is enabled or increased. Operators, depending on their focus of interest, can select one or more modules of the virtual mapping of the drive device and configure them with respect to their level of detail, in order in this way for example to optimize the performance of the time-dependent simulation model or to adapt the simulation model to the available computing resources, for example computing power, computing speed of the computer system executing the model.

The virtual mapping can thus be regarded as a model of the drive device that has the maximum functional scope and for example the maximum level of detail.

The invention puts at the disposal of the operator of an automation system or of a process control system a tool with which they can simulate real drive devices to an extent determined by them and in a level of detail dependent on the extent determined by them. The advantage of the aforementioned flexibility and configurability of the model is that operators can perform the simulation faster, because they do not have to simulate the entire real drive device, but only those aspects in which they are currently interested.

The operators thus has a modular system (modular virtual mapping) containing the modules that map corresponding aspects/properties of the real drive device and that can be configured with respect to their level of detail (for example the number of variables/parameters to be simulated, the number of interfaces, etc.).

Using time-dependent (or dynamic) simulations or time-dependent (or dynamic) simulation models, different time scales (or time constants) and corresponding frequency ranges can be represented as a function of a sampling time (sampling increment)—starting with very fast electromagnetic phenomena through to significantly slower electromechanical phenomena. In order to map a desired phenomenological time constant of a partial aspect of a time-dependent simulation model, the sampling time can normally be selected such that it is smaller by a factor of 10-20 than the smallest time constant that is to be mapped/is relevant to the model.

In this case, in contrast to time-independent simulations (also referred to as a static or frequency-dependent simulation) the time is a monotonically increasing simulation variable. Normally a time-dependent/time-based simulation starts at t=0 and continues with a constant or variable sampling time, until the simulation end time established by the user is reached, wherein, as a function of the selected solution method (“solver”), it is possible within a sampling step for the same step to be executed multiple times (“iteration”), until a defined permissible error is reached.

The time-dependent simulation model provided in accordance with the defined functional scope can be executed. In this case those aspects of the drive device are simulated which are defined in the functional scope.

When configuring the modules with respect to their level of detail it is for example possible to select and/or establish effects to be simulated and/or time constants to be taken into account. When the level of detail of a module changes, the parameterization associated with this module also changes. For example, it is possible for externally specified parameters to be converted in order to satisfy a lower level of detail.

In one form of embodiment it may be expedient if the time-dependent simulation model has an interface, with the aid of which the time-dependent simulation model can be coupled to various other items of software, for example simulation software.

In one form of embodiment it can advantageously be provided that each module of the virtual mapping is associated with a sampling time dependent on the level of detail. It is perfectly conceivable for less weight to be placed on one particular aspect of the drive device than on other aspects. In this case the module that describes this aspect can be configured with a lower level of detail than the other modules. As a result, the performance gain in respect of calculation time can be increased, because the module configured with the lower level of detail permits a higher sampling time.

The sampling time is constant outside the time-dependent simulation model, but can reduce within the simulation model because of the configuration of the modules with respect to their level of detail. To avoid sampling problems, this reduction can decrease in whole multiples of the external communication time.

In one form of embodiment it may be advantageous if each module of the virtual mapping comprises multiple submodules, wherein each submodule is configurable with respect to its level of detail.

In one form of embodiment it may be expedient if multiple different modules of the virtual mapping are selected and configured with respect to their level of detail.

In one form of embodiment it may be expedient if the at least one module has at least one interface. Should multiple modules of the virtual mapping of the drive device be selected when establishing the time-dependent simulation model, these can be linked to one another via the interfaces provided for this purpose.

In one form of embodiment it can advantageously be provided that the virtual mapping comprises a firmware model of the drive device and a physical model of the drive device, wherein the firmware model and/or the physical model is/are modularly constructed, wherein each firmware model module or physical model module is configurable. The physical model can in this case be an emulation of the physical properties. The firmware model is a model of the firmware of the drive device.

In one form of embodiment it may be provided that the physical model comprises a control model module (output voltage: root-mean-square value, 3-phase sine (amplitude variant and frequency variant), pulse-width modulated) and an electrical model module (root-mean-square value model, 3-phase model, high-frequency model).

In this form of embodiment the interface between both modules always remains constant: the controller (the control model module) outputs voltage, the module of the electrical model returns a current (value). The level of detail of both modules can (in principle) be established independently of one another. It may however be expedient if an increased level of detail in one module entails an increased level of detail in the adjoining modules. In this way for example it is possible to prevent the type of inconsistent calculations in which for example a root-mean-square value is calculated in the control model and a high-frequency model in the electrical system is subjected to this (voltages converted to 3-phase voltage sources).

Thus in one form of embodiment it may be provided that the levels of detail of the modules in the simulation model are automatically varied in order to be adapted to one another and in order to achieve a consistency between the levels of detail of the modules or submodules of the model.

In one form of embodiment it may be provided that the virtual mapping comprises a control model (with or without a speed controller), an electrical model (for example a PT2 element) and a mechanical model (PT1 element, differential equation system).

In this form of embodiment it can be provided that in addition the interface between the models is variable. For example, the control model can output either a speed or a torque. The return value is for example the actual speed. The control model can if necessary be supplemented with further control loops of the process, such as position or other process variables.

If the control model comprises a function with a speed controller, it outputs a torque as the output variable. The torque can serve as an input variable for the electrical model. In the electrical model the torque can be subjected to a transmission function, which represents the closed current control loop. In this case the electrical model can be configured with respect to its level of detail. The output of the electrical model—the torque subjected to a transmission function—can then be used as an input into the mechanical model, wherein an actual speed can be calculated from the input, for example with the aid of the differential equations defining the mechanical model. This actual speed can for example be returned to the controller as an actual value.

In other words, the configuration of the electrical and the mechanical model can follow directly on from the configuration of the control model—a consistency can be assumed here between the levels of detail of the models and/or of the modules and the interfaces between the models or between the modules.

Thus in one form of embodiment it may be provided that a consistency between the levels of detail and the interfaces between the models and/or between the individual modules is achieved automatically.

In one form of embodiment it may be provided that the electrical model can comprise one or more of the following modules: supply network module, a module of a network-side converter, an intermediate circuit module, a module of a motor-side converter and/or a motor module. The motor module can for example be present in the form of a mass inertia model.

Each of the modules is configurable with respect to its level of detail. If the overall system behavior is of interest to the user, all modules/components can be selected and preferably (automatically) consistently configured as regards their levels of detail.

If a user for instance selects that for example the network side should not be simulated, because said user for example has no information on this, the supply network module and the module of a network-side converter are not configured. The intermediate circuit module can in this case be configured in the permanent DC voltage source level of detail.

If conversely only the network side is of interest to the user, the motor module is not configured, wherein the module of a motor-side converter can be configured in the 2-phase load (current source) level of detail.

In each case a configuration of the submodules of the electrical model takes place, while maintaining the above-mentioned consistency.

In one form of embodiment it may be provided that the virtual mapping comprises a control model, an electrical model and a thermal model.

Each of the models can, as can also the models already mentioned, be modularly constructed and can be configurable with respect to its level of detail.

In one form of embodiment it may be provided that when configuring the individual models and/or modules the corresponding time constants associated with the respective models and/or modules are matched to one another.

For example, it can take several minutes for a motor to heat up to thermal equilibrium. However, if the simulation of the controller/of the electrical system, of the converter, etc, is configured in accordance with the time constants relevant there (in the μs range), the simulation using the entire simulation model can become correspondingly resource-intensive.

Thus it may be expedient to configure the control model and/or the electrical model (automatically), such that in this case the level of detail is selected which is sufficient for the thermal model of the motor (for example root-mean-square value model), It is precisely this consistency of the time constants of the physical operations of different systems that the invention comprises.

As a function of the level of detail the necessity for specifying all parameters of a controller or of a physical model can for example be eliminated.

The (genuine) firmware can comprise hardware-related software, which is not configurable on a genuine/real drive device or is only configurable to a limited extent. However, it can definitely be configured (to any extent) as the model—firmware model—contained in the virtual mapping.

In one form of embodiment it may be advantageous if the firmware model comprises a model of hardware-related software stored in the control facility—a first model—and a model of control facility software—a second model—or an (exact) copy of the control facility software.

Whether the model of the control facility software is a simulation model, which is used for the (model-based) development of the control code, or a reuse of the complete runtime code/of the entire firmware code (the highest level of detail), specific parts of the controller can be targeted in the entire time-dependent simulation model, which are represented in the simulation model by specific modules of the virtual mapping. In this case the level of detail of the modules in the simulation model can be adapted, for example reduced. A reduction such as this in the level of detail is not possible in a real drive device, particularly because the real components always include all physical domains and they cannot be reduced just to specific domains.

A complete runtime code/the entire firmware code is the code in the form in which it is used in the real drive device (exact copy of the firmware code).

The hardware-related software stored in the control facility is protected and is configurable only to a very limited extent. By providing of a model of this software the opportunity is created to examine the behavior of the drive device in the context of the time-dependent simulation model as a function of different configurations of the software-related stored software.

If the firmware model comprises an exact copy of the control facility software, it is as configurable as the real code. In other words, it is only configurable to the same degree as the real code.

It can advantageously be provided that the physical model of the drive device is modularly constructed and that each physical model module is a model in each case of a physical component (for example of a power module, intermediate circuit, cable, passive filter, motor, etc.) of the drive device, wherein in the case of each physical model module at least one physical domain to be simulated (electrical system, thermal system, mechanical system, etc.) can preferably be selected and a level of detail of the simulation of the at least one physical domain to be simulated is configurable.

The configuration of a physical model module can thus for example take place in three following stages. In a first stage a selection was made as to which physical component to simulate. A corresponding module is added to the time-dependent simulation model. In a second stage a selection is made as to which physical domain of the selected physical component should be simulated. In a third stage it is further established within the selected physical domain which effects and/or time constants are to be taken into account in the simulation.

The following advantages can result for the sampling time. The time step with which the time-dependent simulation model can be processed internally can be constant or else variable. The selection of a lower level of detail can result in runtime advantages (turnaround time) and thus in a performance gain, since for example smaller control time slices are not executed or the selected physical model modules can be processed with a larger sampling (as a function of the smallest necessary time constant to be emulated—normally the increment is selected to be smaller by a factor of 10-20).

In one form of embodiment it may be expedient if the selection and the configuration of the at least one module of the virtual mapping results in an automatic selection and configuration of at least one further module of the virtual mapping associated with the at least one module. As a result, it can be ensured that the time-dependent simulation model is immediately established in a functional form. Based on the configuration of previously selected modules in the simulation model it may happen that at least one “lowest level of detail” (LLoD) of a further, additional module of the virtual mapping is necessary. LLoD relates to the level of detail of said module. Should this be the case, this other module can automatically be selected. In addition it is conceivable for this additional module to be automatically configured, so that its configuration (level of detail of its configuration) corresponds to the configuration of the previously selected modules or matches the configuration of the previously selected modules. This automatism may also be associated with a reduction in the sampling time, if the necessary models/parameters, in other words their phenomenological time constants, require this. This however depends on how the LLoD modules are configured. The LLoD modules can advantageously be configured such that switching them on does not impair or improve/increase the sampling rate.

An LLoD level of detail can for example be a level of detail in which the number of the parameters used for the description of the module is at its lowest (the higher the number of parameters required to establish the module or the model, the higher the level of detail of said module or model). For each function/module a minimal configuration (LLoD) such as this can be provided, in which a simulation of the entire drive device is still possible.

Thus functions realized by additional modules can be bridged by the aforementioned automatic selection and configuration, such that the user also does not need to configure these functions in order to ensure a robust and efficient operation of the time-based simulation model.

It is perfectly conceivable for the user to be informed about the addition of the additional modules via a corresponding configuration interface and for example for an input on the part of the user to be awaited. Users can in this case choose for example between multiple options, which for example permit an automatic configuration for example with a preset LLoD level of detail, or enable them to configure the additional modules themselves and preferably to increase their level of detail.

For example, the selection of a module which describes a current controller can entail the addition of at least one electrical model of the root-mean-square value behavior of the motor and of the supply unit. In other words, if a current controller simulation module were to be selected, an LLoD module would also be selected, which maps a root-mean-square behavior of the motor and of the supply unit.

In addition, the object of the invention is inventively achieved with a computer-aided method, cited in the introduction, for simulating the behavior of a drive device, in that
a previously described time-dependent simulation model is provided,
the time-dependent simulation model is incorporated or embedded in an environment model, in order to simulate the behavior of the drive device in the environment.

In other words, the time-dependent simulation model can for example be regarded as a part of a virtual system, for example of a virtual engineering system, of a virtual process control system, of a virtual automation system, of a virtual machine, for example of a virtual robot, of a virtual tool machine, of a virtual assembly machine or of a virtual automatic assembly machine, etc.

In one form of embodiment it may be provided that a preferably mechanical load to be expected for the behavior is determined, to which the electric machine of the drive device is exposed and the determined load to be expected is used to select a real electric machine in accordance with the load to be expected. To this end, it is possible for example to determine corresponding load profiles of the electric machines, for example motors. Optionally, mechanical movements that are to be expected can be visualized.

In one form of embodiment it may be provided that the environment model comprises one or more virtual programmable logic controllers (PLCs) and the behavior of the drive device in the PLC environment is simulated, in order to validate the virtual one or more PLCs and to commission them, in order also to be able to commission the real PLCs (clearly, if a virtual commissioning fails no real commissioning is permitted and able to take place either).

Furthermore, the object of the invention is inventively achieved in that a simulation model, provided as described above, is used for the simulation of a drive device. In this case, the use of the time-dependent simulation model can be a method for operating and/or for controlling a drive device, in which the behavior of the drive device is simulated with the time-dependent simulation model, and/or a method for troubleshooting errors occurring in a drive device, wherein the behavior of the drive device is simulated using the time-dependent simulation model, in order for example to identify possible errors and/or error sources, and/or a method for commissioning a drive device, wherein the behavior of the drive device is simulated prior to and/or during the commissioning of the drive device using the time-dependent simulation model.

To eliminate or prevent real errors, the behavior of the drive device can for example be simulated in operation and/or during commissioning using the time-dependent simulation model, in order initially to search for possible errors. Then the simulation model can be configured so that the errors do not occur. After this the configuration of the simulation model (the corresponding parameters), in which no errored behavior could be observed, can be transmitted to the real drive device.

In the aforementioned method for operating a drive device, the behavior of the drive device can be simulated with the aid of the time-dependent simulation model and controlled in accordance with the simulation. In this case, the simulation of the drive device can be performed without embedding it in an environment model. The time-dependent model is a standalone model. The advantage of this is that the user can use the same computer program for the simulation and for the control of the drive device.

For instance, it is for example possible to import drive parameters of the control unit or a subset thereof (directly) from the real drive device into the time-dependent simulation model (for example in the event of a fault, in order to investigate this) or to export them into the drive device (for example virtual commissioning of the drive device).

The invention is described and explained in greater detail below in exemplary embodiments represented in the figures, in which:

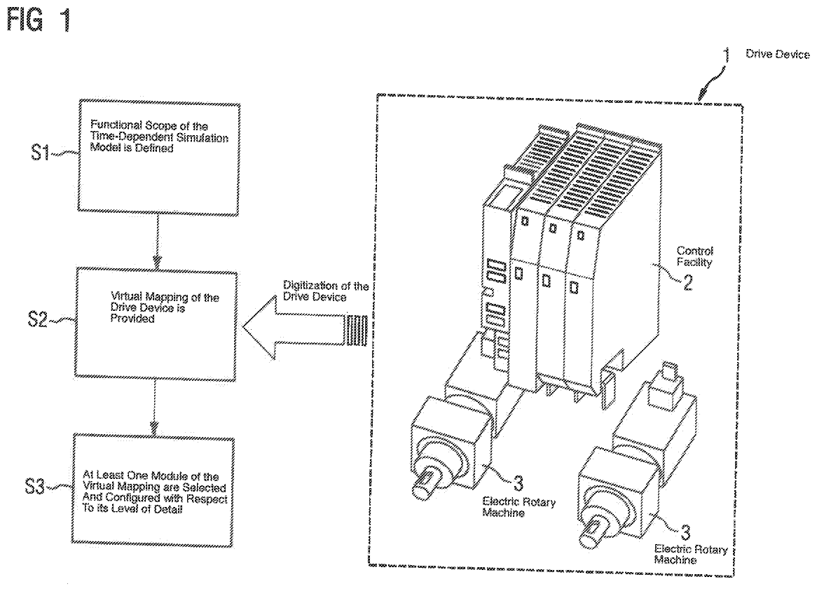

FIG. 1 shows a flow diagram of a computer-implemented method,

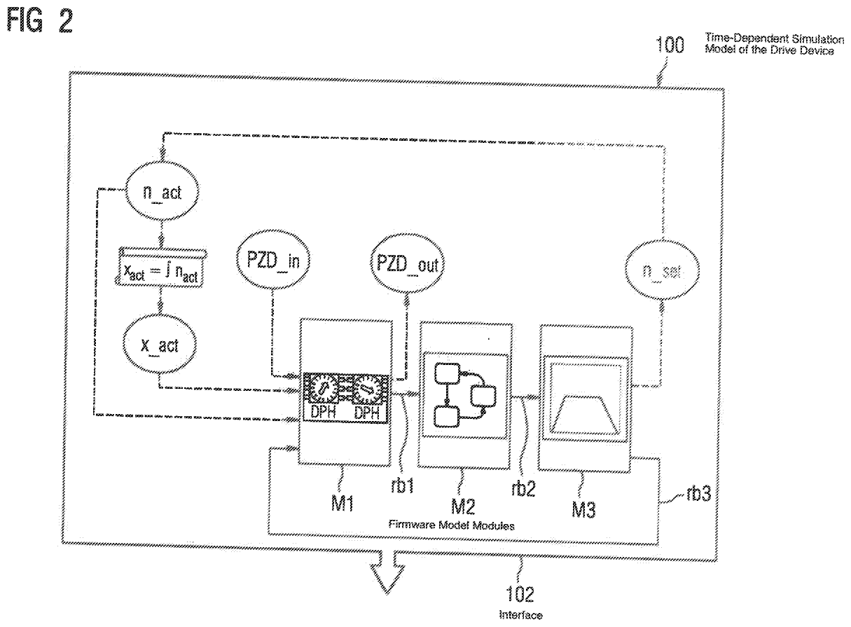

FIG. 2 shows an exemplary embodiment of a time-dependent simulation model,

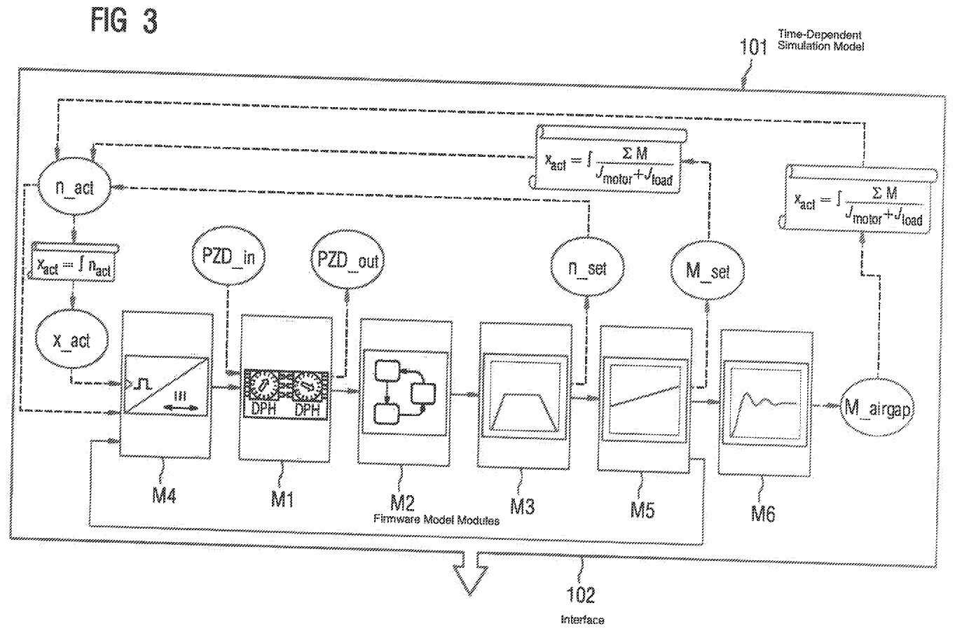

FIG. 3 shows a further exemplary embodiment of a time-dependent simulation model,

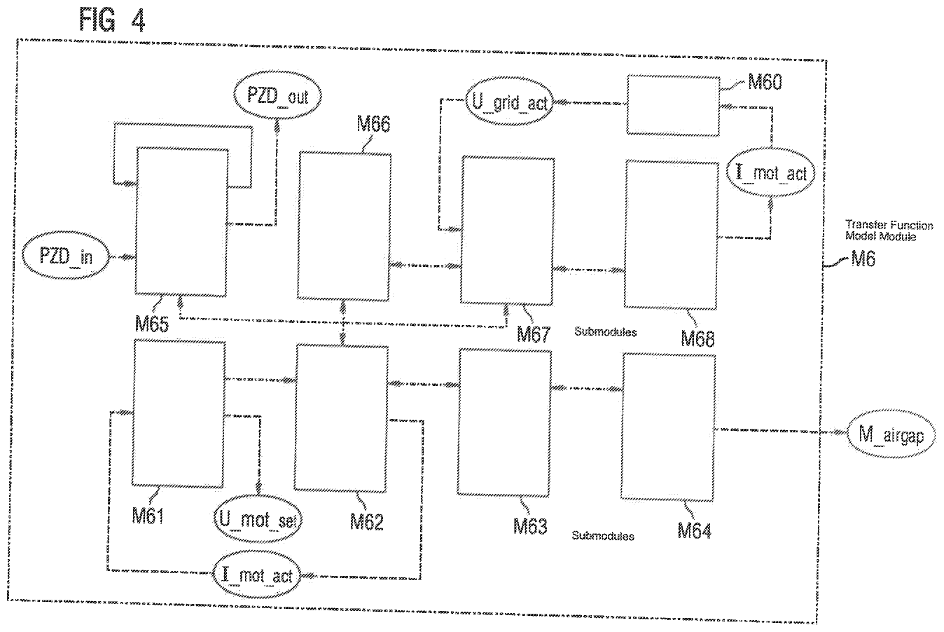

FIG. 4 shows a possible structure of a module of the time-dependent simulation model in FIG. 3,

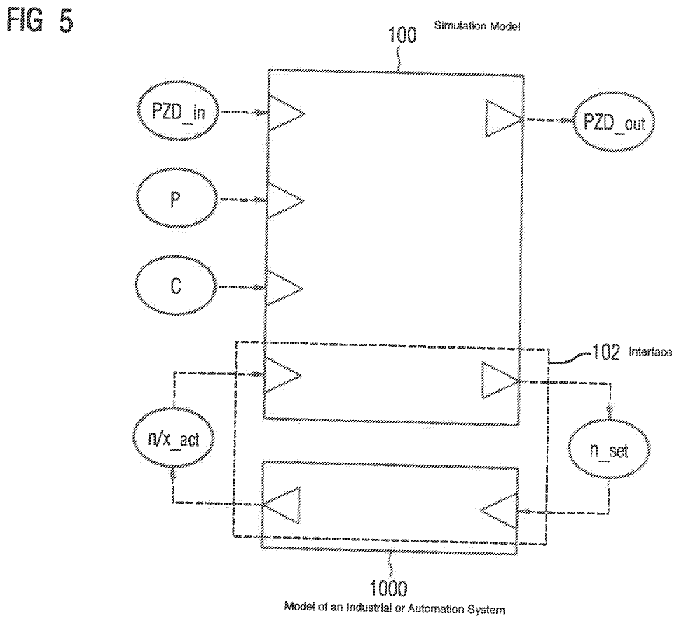

FIG. 5 shows the time-dependent simulation model in FIG. 2 coupled to an environment model,

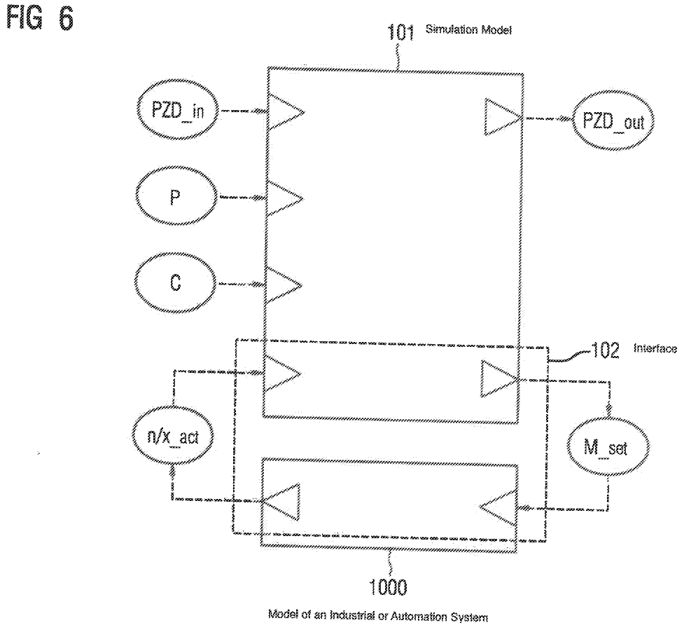

FIG. 6 shows an exemplary coupling of the time-dependent simulation model in FIG. 3 to an environment model, and

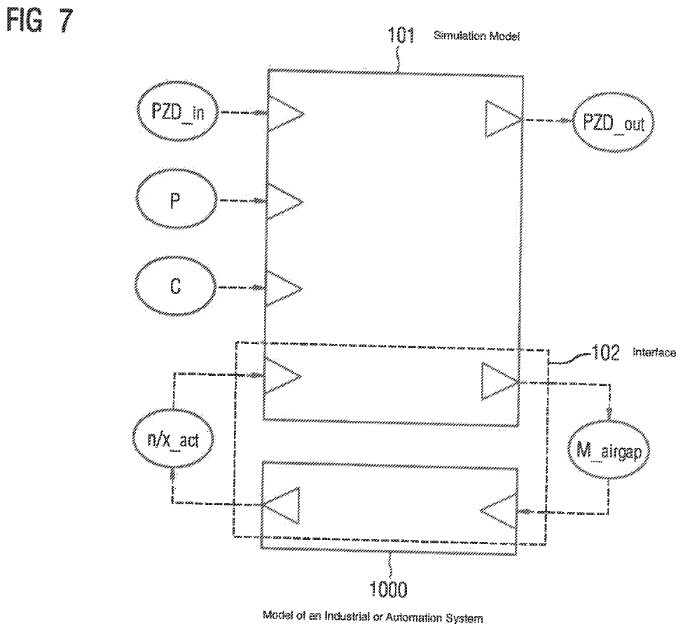

FIG. 7 shows a further exemplary coupling of the time-dependent simulation model in FIG. 3 to the environment model.

In the exemplary embodiments and figures the same or equivalent elements can (but need not) in each case be provided with the same reference characters. In addition, the reference characters in the claims and in the description can be regarded as being merely for a better understanding of the present application and should absolutely not be regarded as any restriction of the subject matter of the present invention.

Reference is first made to FIG. 1. This shows by way of example one possible form of embodiment of the computer-implemented method for providing a time-dependent simulation model of a drive device 1. Time-dependent influences and/or processes are taken into account in a time-dependent simulation model.

The drive device, for which the time-dependent simulation model is to be provided, comprises at least one electric rotary machine 3, for example a motor and at least one supply unit associated with the electric rotary machine. The supply unit can comprise a control facility 2, for example a frequency converter. Such drive devices are often referred to in automation technology as a drive train. For example, the drive device 1 consists of the control facility 2 and the at least one electric rotary machine 3.

In a step S1 a functional scope of the time-dependent simulation model is defined. In other words, a scope of functions which the simulation model of the drive device should have is defined.

In a step S2 a virtual mapping of the drive device is provided. The digitalization of the drive device 1 is illustrated by a thick arrow in FIG. 1.

The virtual mapping is modularly constructed and contains at least two different modules. In this case, each module of the virtual mapping is configurable. The virtual mapping preferably maps specific aspects/properties/behavior of the real drive device 1 in accordance with the defined functional scope.

So that the time-dependent simulation model of the drive device 1 is established in accordance with the defined functional scope, in a step 83 at least one module of the virtual mapping, but preferably multiple, for example three, four, five or six modules of the virtual mapping, are selected and configured with respect to its, preferably their, level of detail, for example via a combination interface.

The simulation model can for example be provided within a computer program.

FIG. 2 shows an exemplary embodiment of a time-dependent simulation model of the drive device 1. To establish the time-dependent simulation model 100 three firmware model modules M1, M2, M3 are selected.

The firmware model module M1 can for example be designed as a model of a device profile/of an interface, preferably of a PROFIdrive. The firmware model module M1—and also other model modules discussed in the context of this disclosure—can have one or more input and/or output interfaces (input/output or I/O). One possibility for configuring a module is via I/O interfaces.

The firmware model module M1 can for example receive the following parameters via its input interfaces (for example from the operator): actual speed value (n_act), position value (x_act), process data word Input to the PLC (PZD_in). The firmware model module M1 can for example output a process data word Output to the PLC (PZD_out), In addition, FIG. 2 shows that the actual position value can be calculated as an integral of the actual speed value.

FIGS. 2 and 3 show the cyclical I/O interfaces (input/output) with dashed arrows.

It can of course be the case that not all or even no I/O of the individual modules M1, M2, etc. are used or are not relevant to the defined functional scope of the time-dependent simulation model. This depends on the level of detail of the individual modules. With a lower degree of detail certain I/O can for example be populated with information with a simplified replacement model Outputs. Such I/O not relevant to the defined functional scope of the time-dependent simulation model can however be used during the debugging.

If the time-dependent simulation model does not contain any I/O it is a time-dependent standalone model.

The firmware model module M2 can for example be designed as a state machine.

The firmware model module M3 can for example be designed as a setpoint channel model. The firmware model module M3 can for example output a speed setpoint value (n_set) via an output interface.

FIG. 2 shows that the time-dependent simulation model 103 has three inputs (n_act, x_act, PZD_in) and two outputs (PZD_out, n_set).

The aforementioned parameters (n_act/set, x_act, PZD_in/out) can be designed as vectors. As a result, drive devices can be modeled and simulated in which multiple drive and/or motor axes and/or imports are associated with a control unit (for example a frequency converter).

Each of the three firmware model modules M1, M2, M3 is configurable with respect to its level of detail. This means for example that each module can be described with greater or less precision as required (depending on a necessary functional scope).

If for example one of the focal points of the simulation is the simulation of the device profile, because the focus of interest is for example on different type of telegram, the firmware model module can comprise further configurable submodules (not shown here), which for example can comprise further input and/or output interfaces, via which further parameters can be adapted or input (for example by an operator).

This type of configurability—simplification of a model module with an additional input of parameter values—relates in the context of the present disclosure to each model module.

All three firmware model modules M1, M2, M3 can be combined with one another (solid arrows in FIGS. 2 and 3). The solid arrows rb1, rb2, rb3 between the modules M1, M2, M3 for example simulate a signal connection between modules of a genuine drive device 1.

In order to close the control loop shown in FIG. 2, the speed setpoint value can for example be given to the firmware model module M1, without thereby entering the actual speed value.

The firmware model modules M1, M2, M3 belong to what is known as a function plan of the drive device (the drive device functions).

FIG. 3 shows an exemplary embodiment of a time-dependent simulation model of the drive device 1. To establish the time-dependent simulation model 101, which is provided for the simulation of a control path of the rotary mechanical system, five firmware model modules M1, M2, M3, M4, M5 and one transfer function model module M6 are selected. The time-dependent simulation model 101 can for example be based on the time-dependent simulation model 100 or can be designed as a development thereof.

The above statement regarding the meaning of the dashed and solid arrows also applies in respect of FIG. 3.

The firmware model module M4 can for example be designed as an encoder evaluation model. The encoder evaluation model can evaluate raw data of a speed encoder, wherein in the real device this is normally (encoded) position values or line markings, encoder channels, etc., which with the corresponding resolution of the encoder and the speed would require a particular sampling increment in the simulation, but which would not generally contribute significantly to increasing the quality of simulation/level of detail. Hence the encoder evaluation is normally simplified by the direct use of the position (x_act) or the speed (n_act). Furthermore, the encoder evaluation module can comprise a specific “encoder state machine”, which can map a behavior defined in accordance with the ProfiDrive specification. These modules can for example be used to realize the function of the reference markers Start-up, etc.

The firmware model module M5 can for example be designed as a speed control model. This module can include regulation of a measured actual speed value to a required speed setpoint value (required by the user or the higher-level control), wherein at the output of the controller a torque can be calculated which goes as a setpoint torque to a current controller or in the model preferably goes directly to the output of the model (ideal transmission behavior of the current control loop->M_set==M_air_gap) or goes into a transmission function of the closed/optimized current control loop (=current controller+voltage actuating element (supply unit)+electric motor model).

Furthermore, this module can offer diverse features of the real firmware, such as speed feed-forward control, additional setpoint values, speed skip frequency bands/filters or torque limitations, etc., in order to ensure a higher quality of control.

The firmware model module M5 can output a torque setpoint value (M_set) via one of its output interfaces (Outputs), it being possible to use this to close the control loop shown in FIG. 3 (see the corresponding arrow), by using the torque setpoint value to calculate the actual speed value in accordance with a configurable load model.

The transfer or transmission function model module M6 can comprise one or more physical model modules and for example output an actual airgap torque value (M_airgap). A model of a closed current control loop can for example be contained in the transfer function model module M6. If required the transfer function model module M6 can be configured in greater detail. For example, the transfer function model module M6 can further comprise a current controller model module and/or a model module which describes the behavior of the electric motor.

The physical model discussed here can additionally comprise further modules not shown here, which for example are provided for the simulation of (further) electric effects, thermal effects (temperature model), ventilation design, recooling in motors, harmonic behavior (EMC for Electromagnetic Compatibility), etc.

Looking at FIGS. 2 and 3 together shows that both time-dependent simulation models 100, 101 can have an interface 102. The interface 102 is provided in order to couple the time-dependent simulation model 100, 101 to various other items of software, for example simulation software. The interface 102 can for example be designed as a functional mock-up interface (FMI).

Also apparent from FIGS. 2 and 3 is that if a particular model module of the virtual mapping of the drive device is selected and configured, it may be necessary to select and configure at least one additional model module associated with the previously selected and configured module, so that the time-dependent simulation model 100, 101 is functional. The selection and configuration of such model modules associated with a selected and configured model module can proceed automatically. In this case, the configuration of these necessary model modules can have a predetermined level of detail, for example LLoD. The physical model module M6 for example has an LLoD level of detail.

Should for example a current controller model module be selected, then a module with an electrical model of the root-mean-square value behavior of the motor and of the supply unit must be selected at the same time.

To summarize, FIGS. 2 and 3 show exemplary embodiments of the inventive time-dependent simulation model, in which the virtual mapping of the drive device comprises multiple model modules, wherein each model module is individually selectable and configurable with respect to its level of detail.

FIG. 4 shows an example of the transfer function model module M6, which comprises nine further submodules M60 to M68. The module M60 is an (internal) network model; the module M61 is a model of the current control; the module M62 is a model of a motor converter; the module M63 is a model of a filter/cable; the module M64 is a model of a motor; the module M65 is a model of an infeed control; the module M66 is a model of a DC link and DC chopper; the module M67 is a model of an infeed converter; the model M68 is a filter model and/or a precharging model and/or a breaker model.

The modules M60 to M68 have still further inputs and outputs: motor voltage setpoint value (U_mot_set), actual motor current value (I_mot_act), process data word Input/Output to the infeed control (PZD_in; PZD_out), grid current setpoint value (I_grid_set), actual grid current value (U_grid_act).

The behavior of the models in the modules M60, M62, M63, M64, M66, M67 and M68 can be described by a shared system of differential equations. This is illustrated with dot-dashed arrows in FIG. 4. These modules are examples of the physical model modules.

Each module of the virtual mapping is associated with a sampling time dependent on the level of detail. Thus for example when establishing the time-dependent simulation models 100, 101 the performance of the simulation model can be optimized in the context of the functional scope. According to the prevailing opinion the performance of a simulation model depends on the sampling time. The higher the level of detail of the individual modules, the lower the performance. Should it emerge for example during the definition of the functional scope that sine simulation of the filter or cable is not relevant during the simulation of the drive device, this module can either be deselected or described by a model with LLoD level of detail.

As already explained, the time-dependent simulation models can have an interface via which it is possible to couple them to various other items of simulation software.

In addition, a standalone model is executable and valid thanks to the configuration of an internal network and mechanical system model and without PLC.

FIG. 5 shows an exemplary embodiment, in which the simulation model 100 is coupled to a model 1000 of an industrial system or an automation system. The behavior of the drive device 1 in the industrial system can then be simulated, in order to check the suitability of the drive device for the industrial system. In the simplest case, if the simulation does not generate any error messages, the genuine drive device is or can be used in the industrial system. The simulation model 100 can be coupled to the model 1000 via the aforementioned interface 102. Actual speed value (n_act), position value (x_act) are examples of outputs of the model 1000, and can be used as inputs for the simulation model 100. The simulation model 100 outputs the speed setpoint value (n_set) which is used as input for the model 1000.

FIG. 5 shows two further interfaces of the simulation model 100: configuration interface C, via which for example particular modules of the aforementioned virtual mapping of the drive device 1 can be selected and deselected, and an interface P. The acyclic specification of parameters of the firmware is possible via the interface P. These can be able to be changed at runtime.

In addition, parameters of the corresponding physical model modules can be specified via the configuration interface C. These are created during the initialization phase and are preferably not changeable during runtime, for example because of possible impairment of the sampling increment. Unlike the other interfaces, the configuration interface C is preferably neither cyclically nor acyclically modifiable.

FIG. 6 shows an exemplary embodiment, in which the simulation model 101 is coupled to the model 1000. The behavior of the drive device 1 in the industrial system can then be simulated. The simulation model 101 can be coupled to the model 1000 via the aforementioned interface 102. In this case, an output M_set (torque setpoint value) of the simulation model 101 is imported into the model 1000. The model 1000 can for example output the actual speed value (n_act) and the actual position value (x_act), which can be used as inputs for the simulation model 100.

FIG. 7 shows an exemplary embodiment, in which—as in FIG. 6—the simulation model 101 is coupled to the model 1000, wherein an output M_airgap (actual airgap torque value) of the simulation model 101 is imported into the model 1000.

Looking at FIGS. 5 to 7 together shows that the more complex the time-dependent simulation model is, the simpler the environment model may be.

In summary, the invention makes it possible to provide time-based simulation models of drives, in which users can, for example via a configuration interface, actively switch/instantiate to themselves only specific aspects of the real drive for the simulation and vary their level of detail. In contrast to the real drive, the model does not require these for the correct mapping of a particular function that the user would like to display. Because of this flexible level of detail the aspects of the real drive that are not required can be omitted, which can result in a time saving.

As described in connection with the present disclosure, the flexible level of detail can relate to partial aspects of the software and/or hardware (firmware model modules and/or physical model modules).

As already shown it is possible to select whether specific control parts are contained in the time-based simulation model, or in how much detail the hardware is mapped in the model. Thus for example it is possible to map only the electrical domain of a system, wherein this can in turn be executed with an increasing level of detail as a mean value model, a fundamental frequency model or a harmonic model.

Although the invention has been illustrated and described in greater detail using exemplary embodiments, the invention is not restricted by the disclosed examples. Variations thereof can be derived by the person skilled in the art, without departing from the scope of protection of the invention, as defined by the following claims.

For example, because of the flexible content of the time-dependent simulation model it is possible to use interfaces of the individual modules offered for the closure of any control loops or to close these in accordance with the configuration inside the model, in order for example to obtain standalone models (see FIGS. 2 to 7, in which the path of the arrows can be changed in a context readily apparent to the person skilled in the art). Fine-grained switching of the paths (arrows) inside a simulation model is possible. Thus a time-dependent simulation model with configurable model building blocks is provided.

At this point it may be noted that by selecting and configuring modules which merely model the behavior of an internal network and internal mechanical system (PLC model module is not selected) an executable and valid time-dependent simulation model can be provided.

FIGS. 2 and 3 for example map a control path of the rotary mechanical system. The invention is not however restricted to mapping the control path of the rotary mechanical system. As is apparent from the totality of the present disclosure, the inventive time-dependent simulation model can comprise a temperature model (ventilation design, for example in switching cabinet modeling, recooling in motors, etc.), harmonic behavior (EMC), etc. These are for example not control loops, but system response/behavior (see for example the discussion on the physical models).

1.-16. (canceled)

17. A computer-implemented method for providing a time-dependent simulation model of a drive device, wherein the drive device comprises an electric machine and a supply unit associated with the electric machine, and comprising a control facility, the computer implemented method comprising:
defining a functional scope of the time-dependent simulation model;
providing a virtual mapping of the drive device, wherein the virtual mapping is modularly constructed, wherein each module of the virtual mapping is configurable with respect to its level of detail;
selecting at least one module of the virtual mapping in order to establish the time-dependent simulation model of the drive device with the defined functional scope, in accordance with the functional scope; and
configuring in accordance with the functional scope the at least one module with respect to its level of detail.

18. The method of claim 17, further comprising associating a sampling time dependent on the level of detail with each module of the virtual mapping.

19. The method of claim 17, further comprising selecting and configuring multiple different modules of the virtual mapping with respect to their level of detail.

20. The method of claim 17, wherein the at least one module has at least one interface.

21. The method of claim 20, wherein in a case of multiple modules, the multiple modules are linked to one another.

22. The method of claim 17, wherein the virtual mapping comprises a firmware model of the drive device and a physical model of the drive device, and further comprising:
modularly constructing the firmware model and/or the physical model; and
allowing each firmware model module or physical model module to be configured.

23. The method of claim 22, wherein the firmware model comprises a first model of hardware-related software stored in the control facility, and a second model of control facility software or a copy of the control facility software.

24. The method of claim 22, wherein the physical model of the drive device is modularly constructed, wherein each physical model module is a model in each case of a physical component of the drive device.

25. The method of claim 24, wherein in a case of each physical model module at least one physical domain to be simulated is selectable and a level of detail of the simulation of the at least one physical domain to be simulated is configurable.

26. The method of claim 17, wherein the selecting and configuring of the at least one module of the virtual mapping results in an automatic selection and configuration of at least one further module of the virtual mapping associated with the at least one module.

27. A computer-aided method for simulating behavior of a drive device, the method comprising:
providing a time-dependent simulation model as set forth in claim 17; and
incorporating the time-dependent simulation model into an environment model in order to simulate the behavior of the drive device in the environment.

28. The method of claim 27, further comprising:
determining a load to be expected for the behavior, to which the electric machine of the drive device is exposed; and
using the determined load to be expected to select a real electric machine in accordance with the load to be expected.

29. The method of claim 28, wherein the load is a mechanical load.

30. The method of claim 27, wherein the environment model comprises one or more virtual programmable logic controllers, and further comprising simulating the behavior of the drive device in the environment in order to validate the virtual programmable logic controllers and to commission them.

31. A method of simulation comprising:
providing a time-dependent simulation model of a drive device as set forth in claim 17;
simulating the drive device with the time-dependent simulation model in order to obtain simulation results; and
using the simulation results are for at least one of the following:
selection of a suitable real drive device for an automation system;
control and/or configuration of a real drive device; and
prevention of errors in operation and/or during commissioning of a real drive device.

32. The method of claim 31, wherein the real drive device is part of an automation system.

33. A computer program embodied on a computer readable storage medium, the computer program comprising commands, which on execution of the computer program by a computer cause said computer to execute a method as set forth in claim 17.

34. A system, in particular an engineering platform, the system comprising means for executing a method as set forth in claim 17.

35. A system, in particular an engineering platform, the system comprising means for executing a method as set forth in claim 27.

36. A system, in particular an engineering platform, the system comprising means for executing a method as set forth in claim 31.

37. A computer-readable storage medium with a computer program as set forth in claim 33.

38. A data stream embodied on a computer readable storage medium, which is adapted such as to transmit a computer program as set forth in claim 33.
